(19) United States
(12) Patent Application Publication
(10) Pub. No.: US 2007/0164112 A1
(43) Pub. Date: Jul. 19, 2007

(54) METHOD AND SYSTEM FOR FACILITATING AIMING OF A MACHINE-READABLE SYMBOL READER, SUCH AS BARCODE READER

(75) Inventor: Michael W. Dant, Cedar Rapids, IA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: INTERMEC IP CORP., Everett, WA (US)

(21) Appl. No.: 11/619,888

(22) Filed: Jan. 4, 2007

Related U.S. Application Data
(60) Provisional application No. 60/756,319, filed on Jan. 4, 2006.

(51) Int. Cl. G06K 7/10

(52) U.S. Cl. 235/454; 235/472.01

(57) ABSTRACT

Electromagnetic energy comprising a visible component and non-visible component is emitted from a reader, wherein the emitted visible component that is emitted forms a pattern indicative of a position of the reader with respect to a target. A portion of the emitted electromagnetic energy is returned from the target and received by the reader. A visible portion or component of the received electromagnetic energy is optically, computationally and/or electrically filtered and a non-visible portion or component is processed to resolve and/or decode the symbol. Additionally, or alternatively, a detector substantially detects only the non-visible portion or component of the electromagnetic energy returned from the symbol.

### CROSS-REFERENCE TO RELATED APPLICATION

This application claims the benefit under 35 U.S.C. § 119(e) of U.S. Provisional Patent Application No. 60/756,319 filed Jan. 4, 2006.

### BACKGROUND OF THE INVENTION

1. Field of the Invention

The present disclosure generally relates to automatic data collection (ADC) devices operable to optically read machine-readable symbols (e.g., barcodes, matrix codes, stacked codes), and more particularly, but not exclusively, relates to techniques to effectively use an aiming beam to position a machine-readable symbol reader with respect to a target machine-readable symbol.

2. Description of the Related Art

The automatic data collection (ADC) arts employ numerous approaches for representing information in machine-readable form. For example, information may be optically represented in machine-readable symbols. Machine-readable symbols are typically composed of machine-readable symbol characters selected from a particular symbology to encode information. Machine-readable symbols typically encode information about an object on which the machine-readable symbol is printed, etched, carried, or attached to, for example, via packaging or a tag.

Symbologies include one-dimensional (1D) symbologies for forming machine-readable symbols commonly referred to as barcode symbols. Symbologies also include two-dimensional (2D) symbologies which provide an increase in information density over one-dimensional symbologies. For example, machine-readable symbols commonly referred to as stacked code symbols typically encode information in two or more lines of vertically stacked one-dimensional symbols. Also for example, machine-readable symbols commonly referred to as matrix or area code symbols typically encode information in a plurality of geometric elements distributed in a pattern within a two-dimensional perimeter.

A variety of machine-readable symbol readers for reading machine-readable symbols formed from characters selected from one-and/or two-dimensional symbologies are known. Machine-readable symbol readers typically employ one of two fundamental approaches for data acquisition, scanning, or imaging. Scanning typically employs a focused beam of emitted or received light to sequentially scan relatively across the machine-readable symbol. In some embodiments, the machine-readable symbol is moved past the reader. In other embodiments, the reader is moved past the machine-readable symbol. In still other embodiments, the beam of light is moved across the machine-readable symbol using a beam deflection system, such as a rotating or oscillating mirror, while the reader and machine-readable symbol remain approximately fixed with respect to one another. Light returned from the symbol is detected, resolved, and/or decoded. Imaging employs a flood illumination of the machine-readable symbol, either with a discrete flood illumination system and/or ambient lighting. A one-dimensional or two-dimensional image capture device, for example, a charge coupled device (CCD) array, captures a digital image of the illuminated machine-readable symbol, typically by electronically sampling the pixels of the image capture device. The captured image is resolved and/or decoded.

The directional nature of conventional machine-readable symbol readers is limiting. For example, the machine-readable symbol reader must be positioned such that a line-of-sight of the machine-readable symbol reader is oriented towards the target machine-readable symbol in order to accurately read the symbol. Additionally, the machine-readable symbol reader must be correctly spaced from the target machine-readable symbol in order to ensure accurate reading. Further, the machine-readable symbol reader may be rotationally positioned with respect to the target symbol, for example, to minimize symbol decoding time.

Positioning the machine-readable symbol reader with respect to a target machine-readable symbol may be particularly difficult where either the reader and/or a tag or item bearing the symbol is handheld. Inexperience, fatigue, or other factors may contribute to a user's inability to correctly position the machine-readable symbol reader with respect to the target machine-readable symbol. Difficulties in positioning become readily apparent in situations where the user has to specifically locate and accurately read a particular individual target symbol among several different symbols that are clustered near one another. For instance, large quantities of inventory each with individual target symbols may be stacked in close proximity to each other. In other instances, a single label may have a plurality of target symbols. In such situations, the user must carefully aim the reader to ensure that the intended symbol is read. In other situations, such as when the item with the symbol is moving and/or when the user is in motion, the user may be required to maintain the reader in a proper position for a sufficiently long period of time for acquisition of the target symbol. Movement of the reader may result in a failed or inaccurate reading of the symbol.

In many instances, the acquisition beam (e.g., scanning beam or flood illumination beam) is outside the visible portion of the electromagnetic spectrum or barely perceptible (i.e., has low-visibility). This hinders the user's ability to correctly position the reader with respect to the target symbol.

To assist the user, a number of machine-readable symbol readers employ a visible aiming beam (i.e., “spotter beam”) in addition to the acquisition beam (i.e., scanning beam or flood illumination beam). For example, imager type symbol readers may employ an aiming beam that provides one or more spots, boxes, crossing dots, or some other suitable one-dimensional or two-dimensional pattern, so as to assist the user in positioning the reader with respect to a target machine-readable symbol. Once the aiming beam has identified the area occupied by the target symbol, the user can activate the acquisition beam to capture an image of the target symbol.

However, the illumination pattern produced by the aiming beam can interfere with image capture via the acquisition beam. Consequently, the aiming beam is temporarily disabled during image capture or during illumination by the acquisition beam in most conventional readers. Temporarily disabling the aiming beam increases cost and/or adds complexity to the reader and its use. For example, turning OFF the aiming beam at the time of image capture, precisely at the time when the reader needs to be correctly positioned, may result in movement of the reader from the correct position with respect to the target symbol, leading to failed or inaccurate readings. Further, turning the aiming beam successively ON and OFF (pulsing) creates a perceptible flashing effect, which may be annoying or distracting to the user. Also, in some environments, such pulsing diminishes the brightness of the aiming beam so that the user may have difficulty seeing the aiming beam. Consequently, an improved approach to aiming and acquiring symbol data in imaging and scanning type symbol readers is desirable.

### BRIEF SUMMARY OF THE INVENTION

In one aspect, a method of operating a machine-readable symbol reader to read machine-readable symbols is provided. One embodiment comprises an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target, and a detector subsystem operable produce a signal indicative of a non-visible component of electromagnetic energy returned from the surface.

In another aspect, an embodiment comprises an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target; and a detector subsystem comprising an optical filter that passes a non-visible component of electromagnetic energy returned from the surface while filtering a visible component of the electromagnetic energy returned from the surface.

In another aspect, an embodiment comprises an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target; and a detector subsystem comprising a detector responsive to a non-visible component of electromagnetic energy returned from the surface and substantially unresponsive to a visible component of the electromagnetic energy returned from the surface.

In another aspect, a method of determining machine-readable encoded information in a plurality of machine-readable symbols is provided. The method comprises emitting electromagnetic energy comprising a visible component and a non-visible component from the machine-readable symbol reader, wherein the emitted visible component forms a pattern indicative of a position of the machine-readable symbol reader with respect to a target; receiving a portion of the emitted electromagnetic energy returned from the target, wherein the received portion of the electromagnetic energy comprises a visible portion and a non-visible portion of electromagnetic energy; and detecting only the received non-visible portion of electromagnetic energy.

In another aspect, a method of determining machine-readable encoded information in a plurality of machine-readable symbols is provided. The method comprises generating a signal based upon a detected portion of electromagnetic energy that is returned from a machine-readable symbol, the electromagnetic energy comprising to a visible component and a non-visible component; preprocessing the signal to substantially remove the visible component of electromagnetic energy; and processing substantially only the information corresponding to the non-visible component of electromagnetic energy in the signal to resolve the machine-readable symbol.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements, as drawn, are not intended to convey any information regarding the actual shape of the particular elements, and have been selected solely for ease of recognition in the drawings.

FIG. 1 is an isometric view of an environment wherein a machine-readable symbol is being read by a machine-readable symbol reader, according to one illustrated embodiment.

FIGS. 2A and 2B are sequential schematic diagrams that illustrate the reading of a machine-readable symbol, according to one illustrated embodiment.

FIG. 3 is a block diagram of a machine-readable symbol reader, according to one illustrated embodiment, wherein an internal filter filters or otherwise removes a visible component of electromagnetic energy returned from the symbol.

FIG. 4 is a block diagram of a machine-readable symbol reader, according to another illustrated embodiment, wherein an external filter receives the return beam so that the visible component is filtered or otherwise removed.

FIG. 5 is a block diagram of a machine-readable symbol reader according to another illustrated embodiment, wherein machine-readable symbol reader includes a visible electromagnetic energy emitter, a non-visible electromagnetic energy emitter, and a detector that detects returning non-visible electromagnetic energy.

FIG. 6 is a block diagram of a machine-readable symbol reader according to another illustrated embodiment, wherein the machine-readable symbol reader includes an emitter that emits visible electromagnetic energy and non-visible electromagnetic energy, and a detector that detects returning non-visible electromagnetic energy.

FIG. 7 is a block diagram of a machine-readable symbol reader according to another illustrated embodiment, wherein the machine-readable symbol reader computationally filters out a visible component of returning electromagnetic energy.

FIGS. 8 and 9 are flow charts illustrating the operation of the logic of FIG. 3 as applied to reading a machine-readable symbol by various embodiments of a machine-readable symbol reader.

### DETAILED DESCRIPTION OF THE INVENTION

In the following description, certain specific details are set forth in order to provide a thorough understanding of various embodiments. However, one skilled in the art will understand that the invention may be practiced without these details. In other instances, well-known structures associated with machine-readable symbol readers, including controllers such as microprocessors, digital signal processors (DSP), application specific integrated circuits (ASIC), illumination subsystems such as flood illumination subsystems and/or scanning illumination subsystems (e.g., focused illuminators and/or focused detectors), and/or optical detectors such as charge coupled device (CCD) arrays, photodiodes, vidicons, and/or other light sensitive devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open sense, that is as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

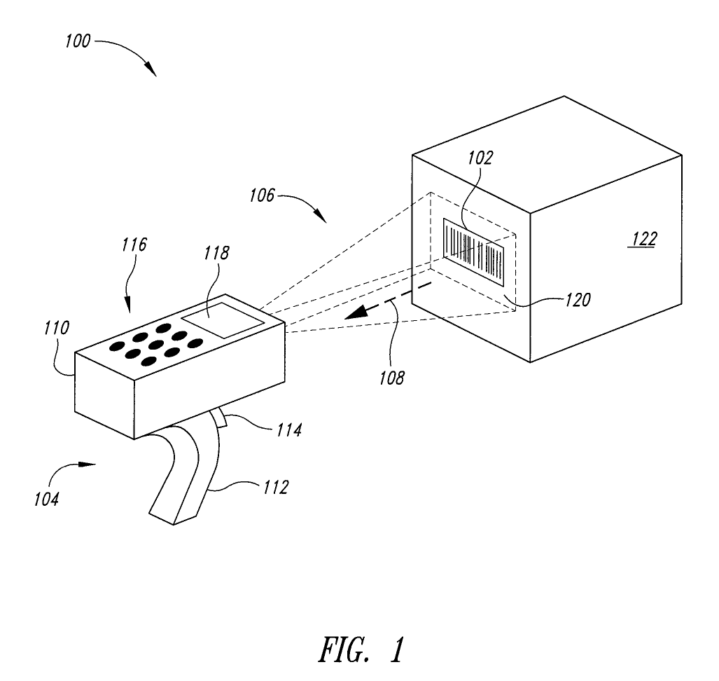

FIG. 1 shows an environment 100 where a machine-readable symbol in the form of a barcode symbol 102 is read by an exemplary embodiment of an automatic data collection (ADC) device in the form of a machine-readable symbol reader 104. While various embodiments of the machine-readable symbol reader 104 are described and illustrated as reading a barcode symbol 102, it is appreciated that such readers 104 may read (e.g., scanning, imaging, resolving, and/or decoding) any suitable machine-readable symbols. Consequently all variations of machine-readable symbols are within the scope of this disclosure.

The machine-readable symbol reader 104 emits or transmits electromagnetic energy as emitted beam 106 towards the barcode symbol 102. The emitted beam 106 includes a portion or component having spectral energy outside of the visible range of the electromagnetic spectrum, or non-visible electromagnetic energy, that is used to acquire information encoded in the barcode symbol 102. As is understood in the arts, the visible range of the electromagnetic spectrum corresponds to a wavelength of approximately 400 nanometers (nm) to 700 nm and is commonly referred to as visible or white light, while the non-visible portions extend below and/or above that range. One advantage of using non-visible electromagnetic energy is that the specific range of electromagnetic energy may be selected such that ambient electromagnetic energy is less likely to interfere with reading, thereby increasing the apparent contrast between the components (e.g., bars and spaces) forming the machine-readable symbol. The emitted beam 106 also includes a portion or component that is in the visible range of the electromagnetic spectrum which may be used to position the machine-readable symbol reader 104 with respect to the barcode symbol 102.

Incident electromagnetic energy on the barcode symbol 102 is reflected back or otherwise returned from the barcode symbol 102 towards the machine-readable symbol reader 104 as a modulated return beam 108. Since the emitted beam 106 includes visible and non-visible electromagnetic energy, the return beam 108 may also include visible and non-visible electromagnetic energy. As noted above, the visible component of the return beam 108 may interfere with the detection of the non-visible portion or component in conventional machine-readable symbol readers.

As discussed in detail below, some embodiments of the machine-readable symbol reader 104 filter or otherwise remove the visible portion or component from the return beam 108, and then detect or otherwise acquire the portion of non-visible electromagnetic energy in the return beam 108. Also as discussed in detail below, other embodiments of the machine-readable symbol reader 104 employ a light sensor or detector that is particularly sensitive in the non-visible range of the electromagnetic spectrum, and consequently, is less sensitive or even immune to electromagnetic energy in the visible range of the electromagnetic spectrum. Accordingly, the barcode symbol 102 is read without interference from the visible portion or component of the return beam 108 that is reflected or otherwise returned from the barcode symbol 102.

As illustrated, machine-readable symbol reader 104 may be portable, and may include a body 110 and a handle 112 configured for being grasped by a user. Alternatively, the machine-readable symbol reader may be a fixed-mount embodiment, which may be attached to, or be part of, a stationary object (e.g., point-of-sale terminal) or moving object (e.g., vehicle mounted).

The machine-readable symbol reader 104 may optionally include an actuation device, illustrated in FIG. 1 for convenience as a trigger 114 that is selectively operable by the user. Once the user has positioned the machine-readable symbol reader with respect to the barcode symbol 102, the user may actuate the trigger 114 to cause the reader to emit the emitted beam 106 and/or to cause the subsequent reading of the barcode symbol 102. Alternative embodiments may use other types of actuation mechanisms to cause emission of the emitted beam 106 and/or subsequent reading of the barcode symbol 102. Examples of an actuation mechanism include, but are not limited to, a push-button, a toggle-switch, a multi-position sensing device configured to sense a plurality of switch positions, a touch-sensitive switch, or a light sensitive device. Furthermore, the functionality of the actuation mechanisms may be alternatively implemented on a multi-function touch-sensitive device, such as a touch pad or the like. In yet other embodiments, actuation may be automatically initiated by an external device, such as, but not limited to, a position sensor, a proximity sensor, a motion detector, or the like.

The machine-readable symbol reader 104 may also include a plurality of other optional manual user input devices 116. For example, one of the optional user input devices 116 may be an ON/OFF switch that activates or deactivates the machine-readable symbol reader 104. Another user input device 116 may provide for changing the mode of operation of the machine-readable symbol reader 104. For example, different machine-readable symbologies may be selectable by the user. It is appreciated that any number of and/or combination of different types of user input devices 116 may be used by various embodiments of the machine-readable symbol reader 104. Further description of the user input devices 116 will be limited to aspects germane to the features of the various embodiments described herein.

The machine-readable symbol reader 104 may further include an optional display 118 operable to indicate an operational status or state of the machine-readable symbol reader 104 to a user. For example, display 118 could be used to indicate whether the machine-readable symbol reader 104 is activated or deactivated. Other information of interest may be displayed on the display 118. For example, the display 118 could be used to indicate successful acquisition and/or decoding of the target barcode symbol 102. The display 118 may be a touch-sensitive screen operable to also receive user input. Further description of information that may be displayed on display 118 will be limited to aspects germane to the features of the various embodiments described herein. The machine-readable symbol reader 104 may include other output devices (not shown) operable to indicate the operation status and/or states to the user. For example, a first audible signal might be emitted by a speaker (not shown) to indicate a successful or unsuccessful symbol acquisition and a second audio signal to indicate a successful decoding of the barcode symbol 102.

As noted above, exemplary embodiments of the machine-readable symbol reader 104 transmit the emitted beam 106 having a portion of visible light towards and onto the barcode symbol 102. The visible portion of the emitted beam 106 enables a user to position the machine-readable symbol reader 104 with respect to the barcode symbol 102. In the exemplary embodiment of FIG. 1, the visible indicator is illustrated as an illuminated region 120 on a substrate such as container 122 bearing the barcode symbol 102 such that the user perceives that the machine-readable symbol reader 104 is at least in proper position with respect to the target barcode symbol 102. This is conceptually illustrated by showing that the illuminated region 120 encompasses the barcode symbol 102. Other variations of the illuminated region 120 are described hereinbelow.

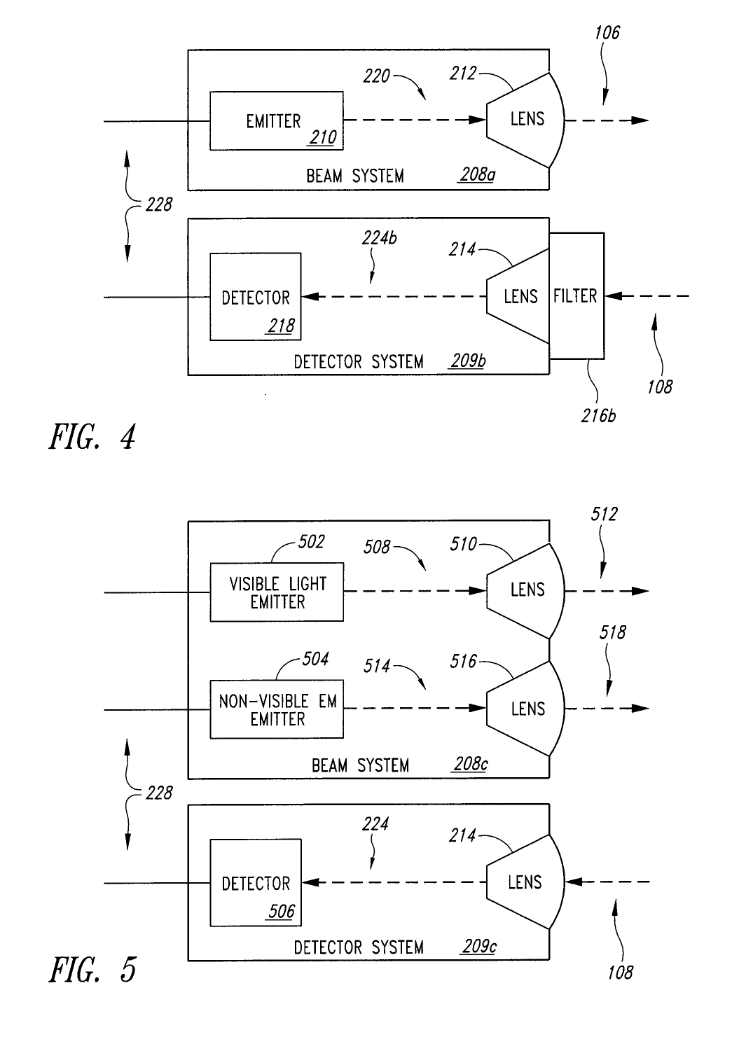

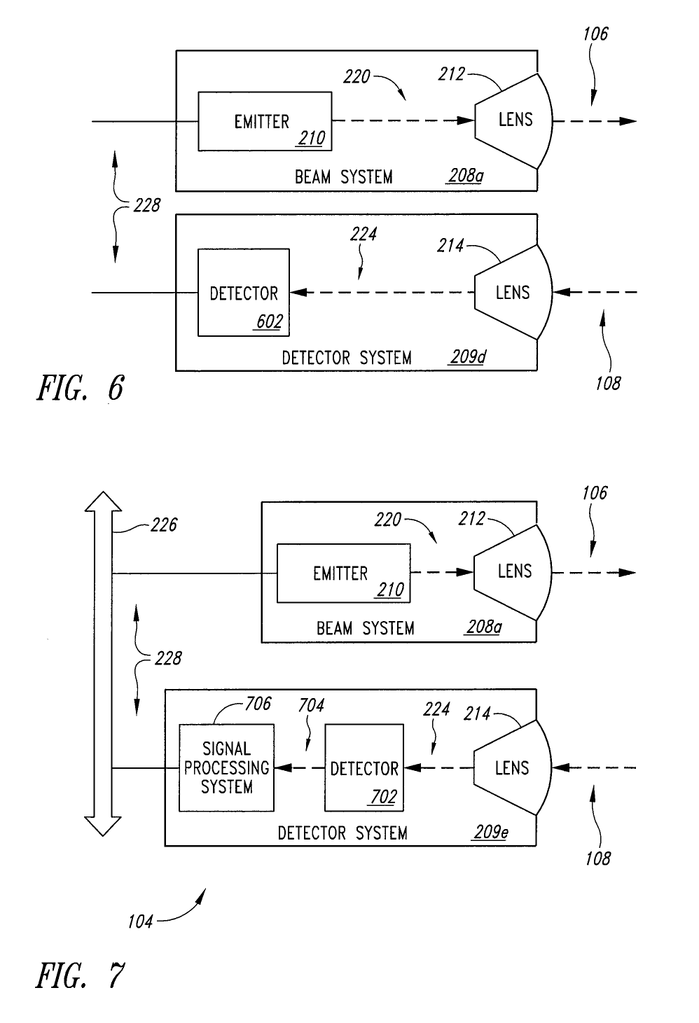

In one exemplary embodiment, the visible portion or component of return beam 108 is filtered such that substantially only the non-visible electromagnetic energy remains. Accordingly, with this embodiment, the non-visible portion is detected by the machine-readable symbol reader 104. In another exemplary embodiment, a detector 506 (FIG. 5) is sensitive only to, or particularly to, the non-visible electromagnetic energy. Accordingly, with this embodiment, the interfering visible portion or component of the return beam 108 is not detected. In yet another exemplary embodiment, machine-readable symbol reader 104 comprises a detector 602, sensitive to both visible and non-visible electromagnetic energy, and further comprises an electronic signal processing system 606 (FIG. 6) that electronically and/or computationally filters out the visible portion or component of detected return beam 108 such that the non-visible electromagnetic energy portion is used to determine the information encoded on the barcode symbol 102. These various embodiments are described in greater detail hereinbelow.

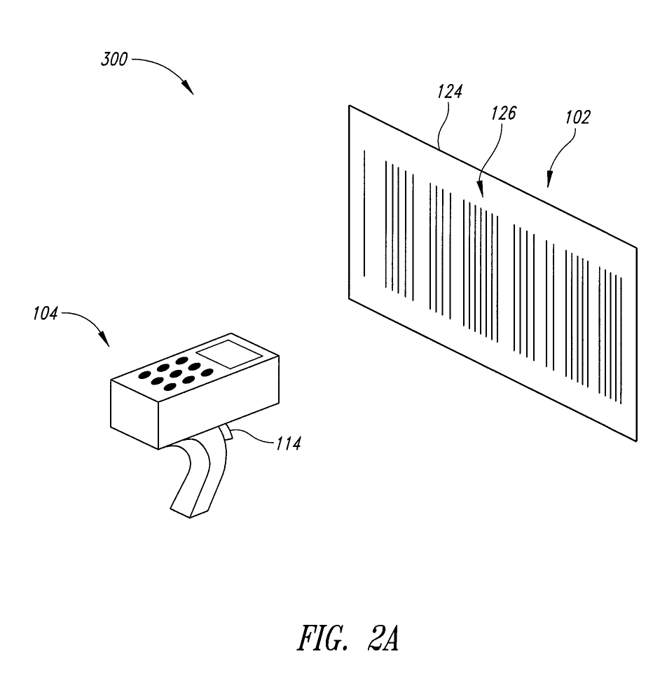

FIGS. 2A and 2B illustrate a method of orienting a machine-readable symbol reader 104 with respect to a barcode symbol 102. For convenience, the barcode symbol 102 is illustrated as being printed on a label 124 and is illustrated as comprising a series of vertically oriented bars 126. As noted above, any suitable machine-readable symbology may be employed, and such symbology may reside on any suitable medium including the product or container itself.

As illustrated in FIG. 2A, a user initially positions the machine-readable symbol reader with a line-of-sight of the reader 104 generally oriented towards the label 124. As illustrated in FIG. 2B, the machine-readable symbol reader 104 generates and transmits the emitted beam 106 (denoted by the arrows) towards the label 124 upon actuation of the trigger 114 by the user. As the emitted beam 106 illuminates the label 124, an illuminated region 120 is discernable and/or perceivable by the user.

The position of the illuminated region 120 with respect to the barcode symbol 102 provides a perceptible indication to the user whether or not the machine-readable symbol reader 104 is properly positioned for reading the bar code symbol 102, and allows the user to correct the position with real-time optical feedback. For example, an illuminated region 120 that encompasses a portion of the barcode symbol 102 as well as a portion of the label 124 extending beyond the barcode symbol 102 may indicate that the reader 104 is not positioned in proper alignment with the barcode symbol 102 (i.e., yaw and/or pitch axes). Also for example, an illuminated region 120 that is too small to encompass the entire length of the barcode symbol 102, or the entire area of a matrix symbol, may indicate that the reader 104 is too close to the barcode symbol 102. An illuminated region 120 that is much larger than the barcode symbol 102 may indicate that the reader 104 is too far from the barcode symbol 102. Where the illuminated area has a major and minor axis, a skew or angular rotation between the major or minor axis of the illuminated region 120 with respect to a major or minor axis of the barcode symbol 102 may indicate that the reader 104 is not positioned in the correct angular relationship (i.e., roll axis) to the barcode symbol 102.

Accordingly, the user may adjust the position of the machine-readable symbol reader 104 until the user is satisfied with the position of the illuminated region 120 with respect to the barcode symbol 102. At some point, the user has suitably positioned machine-readable symbol reader 104 with respect to the barcode symbol 102. For example, with respect to FIG. 2B, the user may move the machine-readable symbol reader closer to the label 124 such that the illuminated region 120 becomes smaller and is overlaying the barcode symbol 102, denoted as the smaller illuminated region 128. Once the machine-readable symbol reader 104 is acceptably aligned, oriented, or otherwise positioned with respect to the barcode symbol 102, the machine-readable symbol reader 104 may then accurately and reliably acquire the return beam 108.

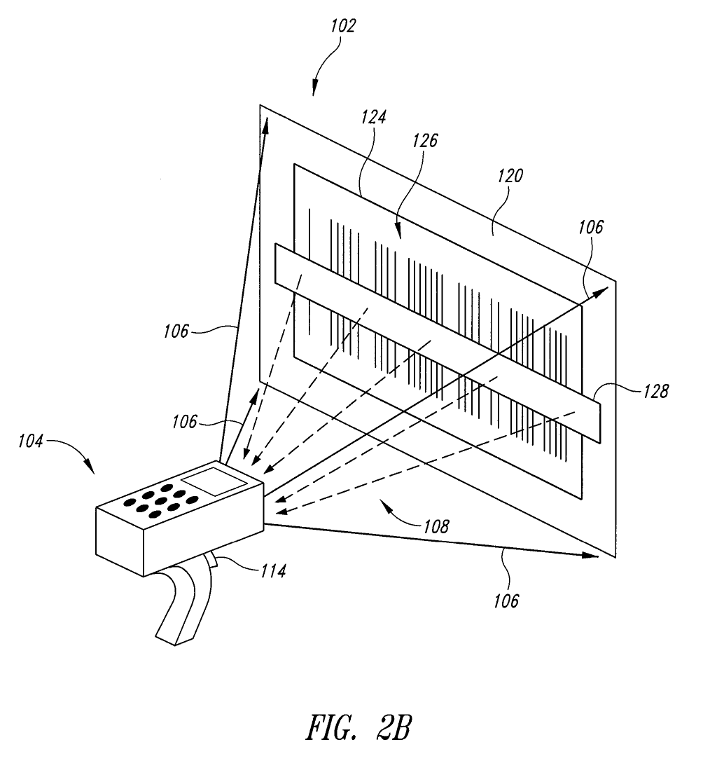

FIG. 3 shows a machine-readable symbol reader 104a according to one illustrated embodiment. In addition to the components described in reference FIG. 1 above, the machine-readable symbol reader 104a comprises a processing system 202, one or more memories 204, an input device interface 206, an illumination beam subsystem 208a, and a detector subsystem 209a. The illumination beam subsystem 208a, in the exemplary embodiment of FIG. 3, comprises an emitter 210 and a lens assembly 212. The detector subsystem 209a comprises a lens assembly 214, a filter 216a and, a detector 218.

The emitter 210 emits a light beam 220 that is optically communicated to lens assembly 212. The lens assembly 212 receives the beam 220 and outputs the emitted beam 106. In this exemplary embodiment, emitter 210 emits electromagnetic energy, including a portion or component in the visible range of the electromagnetic spectrum, as well as a portion or component outside of the visible range of the electromagnetic spectrum (i.e., non-visible electromagnetic energy). The visible portion or component illuminates a region that encompasses a field-of-view of the machine-readable symbol reader 104. As noted above, the illuminated region 120 (FIG. 1) provides a perceptible indication to a user for positioning (e.g., aligning, orienting, and/or spacing) the machine-readable symbol reader 104awith respect to the target barcode symbol 102.

A portion of the incident electromagnetic energy from the illuminated region 120 is reflected back or otherwise returned towards the machine-readable symbol reader 104, denoted as the return beam 108. Accordingly, the return beam 108 may include a portion or component of visible electromagnetic energy, as well as a portion or component of non-visible electromagnetic energy.

The return beam 108 is received by the lens assembly 214. The lens assembly 214 may provide environmental protection to the internal components of the machine-readable symbol reader 104a and/or may comprise one or more optical components to optically condition the return beam 108 to form intermediate beam 222. For example, the lens assembly 214 may include an aperture that focuses return beam 108, that polarizes the return beam 108, and/or that limits the return beam 108 to a smaller area of the illuminated region 120.

In this exemplary embodiment, the lens assembly 214 communicates the intermediate beam 222 to the filter 216a. The filter 216a removes the visible portion or component of electromagnetic energy from intermediate beam 222 to create a filtered beam 224a including substantially only non-visible electromagnetic energy.

The filtered beam 224a is optically transmitted from filter 216a to the detector 218. In this exemplary embodiment, the detector 218 may be sensitive to frequencies or wavelengths of electromagnetic energy in the visible range of the electromagnetic spectrum, as well as the non-visible frequencies or wavelengths which are of interest for reading the symbol 102. Thus, the filter 216a prevents or reduces the inference caused by the visible portions or components of electromagnetic energy with the detector 218.

Detector 218 generates and communicates a signal (e.g., analog scan signal or digital pixel representation) onto a bus 226. The processing system 202, for example one or more microprocessors, DSPs and/or ASICs, executes logic 230 to process the received signal from detector 218 so that the information encoded in the barcode symbol 102 (FIG. 1) is determined. The logic 230 may be stored in memory 204 as illustrated, or may be hardwired or otherwise encoded in the processing system 202. Accordingly, information encoded in the barcode symbol 102 may be determined substantially without interference from the visible light portion or component which may be reflected back or otherwise returned from the illuminated region 120.

The above-described emitter 210 may emit a limited range of the visible electromagnetic spectrum so that the user views a “colored” illuminated region 120, or may emit the entire range of the visible electromagnetic spectrum such that the user views a “white” illuminated region 120. In alternative embodiments, if color is desired for the illuminated region 120, the lens 212 may have a color filter, or a separate color filter may be added to the machine-readable symbol reader 104. Some embodiments may additionally, or alternatively, employ a polarizing filter.

As noted above, emitter 210 emits non-visible electromagnetic energy. In one embodiment, emitter 210 emits electromagnetic energy that is greater than 700 nm. In another embodiment, emitter 210 emits electromagnetic energy that is less than 400 nm. In yet another embodiment, emitter 210 emits electromagnetic energy that is both greater than and less than 400 to 700 nm.

As noted above, return beam 108 comprises reflected or returned electromagnetic energy having at least a portion or component that is outside of the visible range of the electromagnetic spectrum and a portion or component in the visible range. In the exemplary embodiment of FIG. 3, the filter 216a removes the visible light portion or component of the received return beam 108. The remaining electromagnetic energy passing through filter 216a has wavelengths, accordingly, greater than and/or less than approximately 400 to 700 nm. Any suitable optical filter or optical filtering means may be employed by the various embodiments.

As noted above, detector 218 generates and communicates a signal to processing system 202 corresponding to the detected non-visible electromagnetic energy. Processing system 202 may then resolve the elements of the barcode symbol 102 and/or decode the information encoded in the barcode symbol 102. It is appreciated that detector 218 may be one of any detector systems that is configured to generate and then transmit a signal suitable for processing system 202. Accordingly, detector 218 is illustrated for convenience as a single component of the machine-readable symbol reader 104. The specific process and/or system used by detector 218 is not described in detail herein because such detectors are too numerous to conveniently describe. It is understood that any suitable detector 218 that detects electromagnetic energy may be used by the various embodiments described herein. All such detector processes and systems are intended to be included within the scope of this disclosure. Accordingly, for brevity, further description of detector 218 will be limited to aspects germane to the features of the various embodiments described herein.

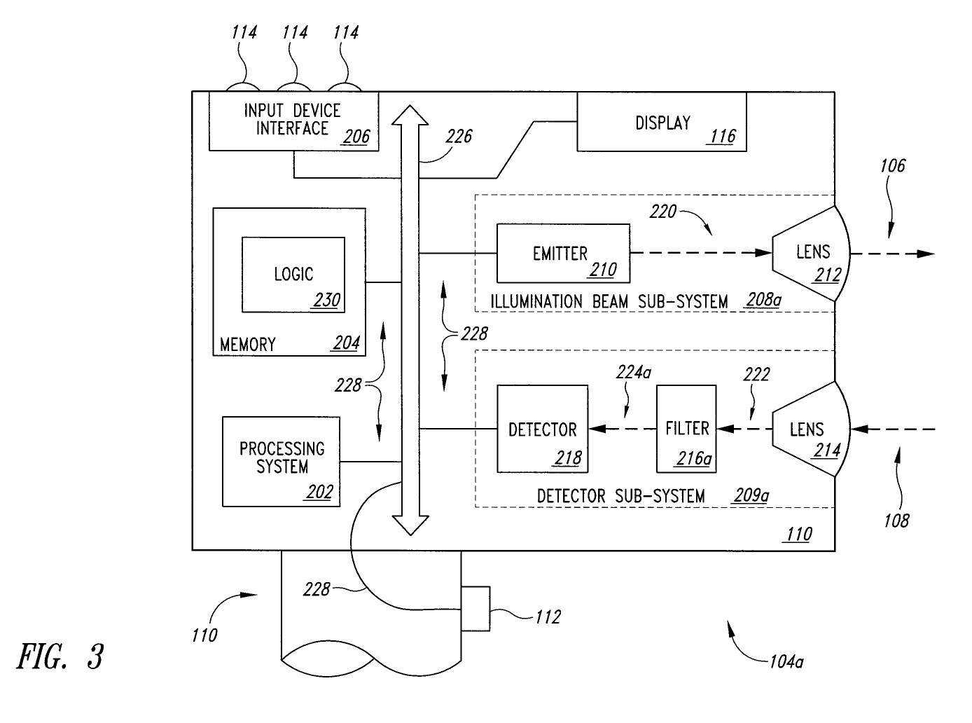

FIG. 4 shows an alternative embodiment of a detector system 209b wherein a filter 216b positioned in the optical path before the lens assembly 214 substantially filters the visible portion or component from the return beam 108. The remaining electromagnetic energy passing through the filter 216b substantially is, accordingly, less than 400 nm and/or greater than 700 nm, depending upon the embodiment. This remaining non-visible electromagnetic energy is communicated to the lens assembly 214 which may further optically condition the received non-visible electromagnetic energy. The filtered and conditioned beam 224b is then received by detector 218.

FIG. 5 shows an alternative embodiment of a beam system 208c comprising a visible electromagnetic energy emitter 502 and a non-visible electromagnetic energy emitter 504. Detector system 209c comprises a detector 506 that detects returning electromagnetic energy emitted by the non-visible electromagnetic emitter 504. The range of frequency of electromagnetic energy output by the non-visible electromagnetic emitter 504 may correspond to or overlap the range of non-visible electromagnetic energy detectable by the detector 506.

Visible electromagnetic energy emitter 502 emits visible light 508 that is within the range of approximately 400 to 700 nm. A lens assembly 510 transmits the visible light 512 along a line-of-sight of the machine-readable symbol reader 104 toward the target barcode symbol 102. Accordingly, the visible electromagnetic energy emitter 502 and its associated lens assembly 510 can be customized for generating a desired illuminated region 120 (FIGS. 1 and 2B). For example, the size and/or shape of the illuminated region 120 may be customized. Additionally, or alternatively, selected colors of visible light may be emitted by the visible electromagnetic energy emitter 502, or colored visible light may be emitted if color filtering is employed.

The non-visible electromagnetic energy emitter 504 and detector 506, and/or their associated lens assemblies 516 and 214, may be customized for generating and detecting a portion of the electromagnetic spectrum that is outside of the range of visible electromagnetic energy. That is, non-visible electromagnetic energy emitter 504 emits non-visible electromagnetic energy 514. Non-visible electromagnetic energy emitter 504 can be selected to emit any desired range of non-visible electromagnetic energy. Preferably, non-visible electromagnetic energy emitter 504 outputs electromagnetic energy that corresponds to the range of electromagnetic energy detectable by detector 506. In other embodiments, the emitted range and the detected range of electromagnetic energy at least overlap.

FIG. 6 shows an alternative embodiment of a detector system 209d comprising the above-described emitter 210 that emits both visible electromagnetic energy and non-visible electromagnetic energy, and a detector 602 that detects only returning non-visible electromagnetic energy. Detector 602 may be any suitable detection device that is particularly sensitive or only sensitive to the non-visible electromagnetic energy or a portion thereof. In one exemplary embodiment, detector 602 may be operable and/or configured to detect a range of the electromagnetic energy spectrum about a specified (nominal) value that is outside of the range of visible light. Accordingly, one embodiment uses a detector 602 having a nominal value that is greater than 700 nm such that the range of the detectable electromagnetic energy spectrum is greater than 700 nm. Another embodiment uses a detector 602 having a nominal value that is less than 400 nm such that the range of the detectable electromagnetic energy spectrum is less than 400 nm.

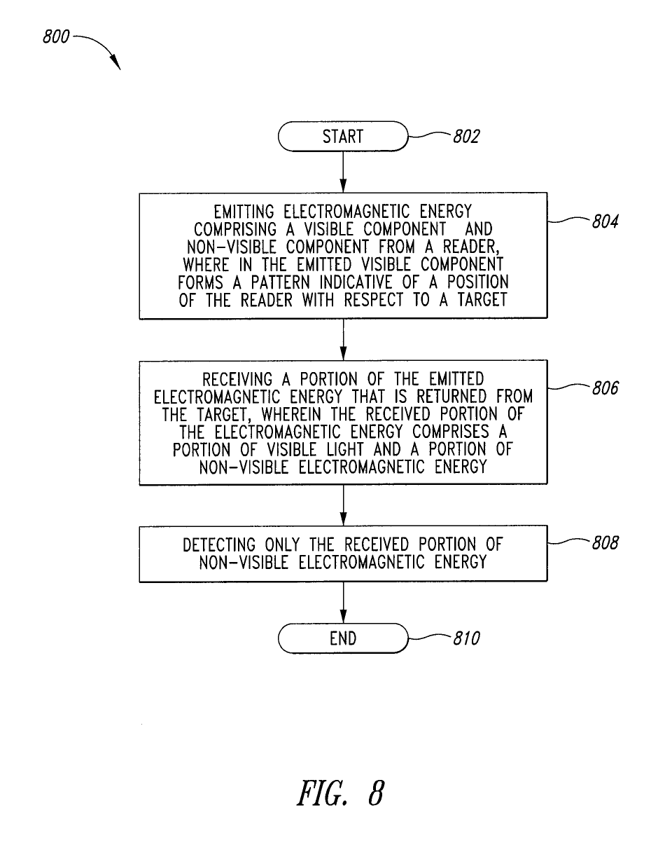

FIG. 7 shows an alternative embodiment of a machine-readable symbol reader that computationally filters return beam 108. Emitter 210 emits electromagnetic energy, illustrated as beam 220, that includes at least a visible portion or component in addition to a non-visible portion or component of electromagnetic energy. As noted above, the lens assembly 212 directs the emitted beam 106 along the line-of-sight of the machine-readable symbol reader 104. Electromagnetic energy incident on a barcode symbol 102 (not shown in FIG. 7) reflects or is otherwise returned from barcode symbol 102, and is received by the lens assembly 214. The received return beam 108 contains visible portions or components of the electromagnetic energy as well as non-visible portions or components of the electromagnetic energy. The lens assembly 214 conditions the return beam 108, providing an optically conditioned beam 224 to a detector 702. Compared to the above-described embodiment illustrated in FIG. 2, this embodiment omits the filter 216 (FIG. 3) and instead computationally filters out returning visible portions. In some embodiments, some level of prefiltering or polarization of the return beam 108 may be performed by other filters or filtering means.

Detector 702 is operable to detect wavelength and/or frequency of returning electromagnetic energy in conditioned beam 224. An output signal 704 is communicated from detector 702 to the signal processing system 706. Signal processing system 706 electronically and/or computationally processes the received output signal 704 to substantially filter or remove information corresponding to the visible portion or component. Accordingly, a signal corresponding substantially to the non-visible electromagnetic energy of the return beam 108 remains. Such may be communicated onto bus 226 (FIG. 3) for processing by the processing system 202 which may determine the information encoded in the barcode symbol 102 from the signal.

In one embodiment, signal processing system 706 comprises a processor or preprocessor that executes logic to computationally filter or remove the visible portion or component, and to computationally determine the non-visible electromagnetic energy portion based upon a selected wavelength or frequency, selected wavelength or frequency range, or another corresponding parameter. Thus, signal processing system 706 computationally removes information corresponding to the visible portion or component of electromagnetic energy reflected back or otherwise returned from the barcode symbol 102 such that substantially only the non-visible electromagnetic energy is processed. Accordingly, the output signal 704 contains information that is substantially free of interference from the visible portion or component used by the user for positioning the machine-readable symbol reader 104. The output signal 704 is saved into memory 204 (FIG. 3), or into another suitable memory device such as a buffer or the like, for later processing by the processing system 202 (FIG. 3).

In another embodiment, signal processing system 706 comprises a processor or preprocessor that executes logic to selectively analyze a predefined nominal wavelength and/or frequency, a predefined range of non-visible electromagnetic energy, or another corresponding parameter outside of the visible light spectrum. Here, the signal processing system 706 directly determines the information encoded in the barcode symbol 102. Thus, signal processing system 706 computationally evaluates or analyzes only the non-visible portion or component of the returned electromagnetic energy. With this embodiment, the output signal 704 may be saved into memory 204, or into another suitable memory device such as a buffer, register, or the like for later processing by the processing system 202 (FIG. 3).

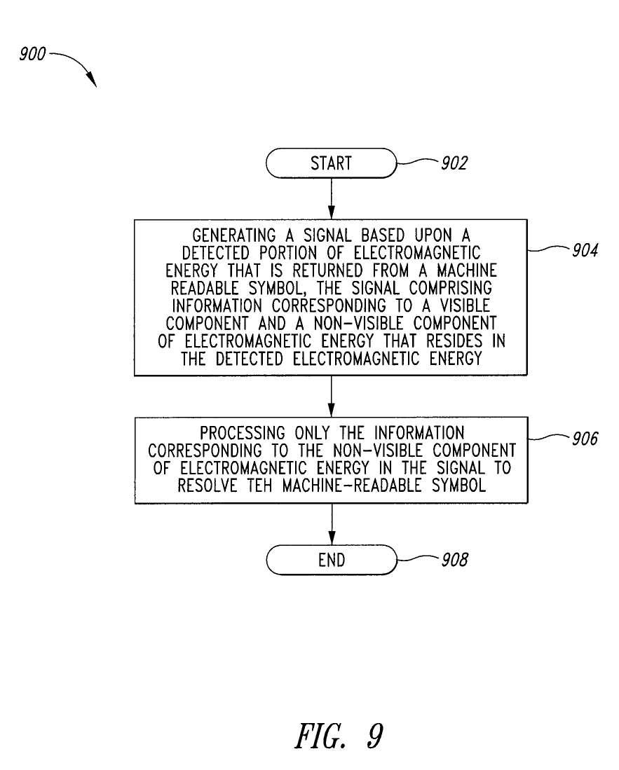

FIGS. 8 and 9 show methods 800 and 900, respectively, illustrating the operation of the logic 230 of FIG. 3 as applied to reading a barcode symbol 102 by embodiments of a machine-readable symbol reader 104. The flow charts 800 and 900 show the architecture, functionality, and operation of a possible implementation of the software, hardware or firmware for implementing the logic 230 (FIG. 3). In this regard, each block may represent a module, segment, or portion of code which comprises one or more executable instructions for implementing the specified logical function(s). It should also be noted that in some alternative implementations, the functions noted in the blocks may occur out of the order noted in FIGS. 8 and/or 9, may include additional functions, and/or may omit some functions. For example, two blocks shown in succession in FIGS. 8 and/or 9 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process illustrated in FIG. 8 starts at block 802. At block 804, electromagnetic energy comprising a visible component and non-visible component is emitted from a reader, wherein the emitted visible component forms a pattern indicative of a position of the reader with respect to a target. At block 806, a portion of the emitted electromagnetic energy that is returned from the target is received, wherein the received portion of the electromagnetic energy comprises a visible portion or component and a non-visible portion or component of electromagnetic energy. At block 808, only the received non-visible portion or component of electromagnetic energy is detected. The process ends at block 810.

The process illustrated in FIG. 9 starts at block 902. At block 904, a signal is generated based upon a detected portion of electromagnetic energy that is returned from a machine-readable symbol, the signal comprising information corresponding to a visible portion or component and a non-visible portion or component of electromagnetic energy that resides in the detected electromagnetic energy. At block 906, only the information corresponding to the non-visible portion or component of electromagnetic energy in the signal is processed to resolve the machine-readable symbol. The process ends at block 908.

Logic 230 (FIG. 3) may further include optional instructions to cause the machine-readable symbol reader 104 to perform a variety of other operations in additional to instructions used to determine the information encoded in the barcode symbol 102 (FIG. 1). For example, but not limited to, logic 230 is executed so that processing system 202 may cause emitter 210 to emit beam 220, may receive information corresponding to the return beam 108 from detector 218, may determine information of interest corresponding to the determined information encoded in the barcode symbol 102, may receive and/or transmit information to/from the input device interface 206, may respond to an actuation signal from the actuation device 112, and/or may transmit information to the optional display 118.

In variations of the above-described embodiments, selected components individually described may be combined into a single component. For example, the detector 218, the filter 216, and/or lens assembly 214 may be combined into a single component. Similarly, the emitters 210, 502, and/or 504 may be combined with their respective lens assemblies 212, 510, and 516, and/orthe above-described colorfilters or filter 216, may be combined into a single component. Alternatively, lens assemblies 212, 214, 510, and/or 516 may be omitted if the electromagnetic energy emitted by the emitters 210, 502, and/or 504 is suitable for transmitting directly to the targeted barcode symbol 102. In some embodiments, lens assemblies 212, 214, 510, and/or 516 may be formed into a single simple or compound lens. If filters are employed, filters may take the form of a coating on a surface of the lens or may be inherent in the composition of the lens itself. It is appreciated that the various combinations of the above-described components can be configured as desired depending upon the embodiment.

For brevity, other components tangentially related to the generation, transmission, and/or receiving of the above-described electromagnetic energy (e.g., rotating or pivoting mirrors or prisms) have not been described herein. For example, if a scanning beam system is employed by an embodiment of the machine-readable symbol reader 104, the components associated with scanning have not been described for brevity. All such variations are intended to be included within the scope of this disclosure.

For convenience, the above-described illuminated region 120 was illustrated as a rectangle on FIGS. 1 and 2B. The illuminated region 120 may be any suitable visible indicator that is perceptible by a user to determine the position of the machine-readable symbol reader 104 with respect to the target barcode symbol 102. For example, the illuminated region 120 may take the shape of an ellipse or other geometric pattern. Or, in other embodiments, the visible indicator may be presented as one or more lines and/or points which define an area that will be scanned. All such forms of a illuminated region 120 are intended to be included within the scope of this disclosure.

The components in the above-described exemplary embodiments are communicatively coupled to each other via communication bus 226 and connections 228, thereby providing connectivity between the above-described components. In alternative embodiments, the above-described components may be connectively coupled in a different manner than illustrated in the various figures. For example, one or more of the above-described components may be directly coupled to each other, or may be coupled to each other via intermediary components (not shown). In some embodiments, communication bus 226 is omitted and components are coupled directly to each other using suitable connections.

Processing system 202 (FIG. 3) and/or signal processing system 706 (FIG. 6) may be a specially designed and/or fabricated processing system, or a commercially available processor system. Non-limiting examples of commercially available processor systems include, but are not limited to, an 80x86 or Pentium series microprocessor from Intel Corporation, U.S.A.; a PowerPC microprocessor from IBM; a SPARC microprocessor from Sun Microsystems, Inc., a PA-RISC series microprocessor from Hewlett-Packard Company, or a 68xxx series microprocessor from Motorola Corporation. In other embodiments, the functionality performed by processing system 202 in accordance with logic 230 may be implemented using a solid state system. All such variations are intended to be included within the scope of this disclosure.

For convenience, the exemplary embodiments of the machine-readable symbol reader 104 are described herein as acquiring, by scanning or imaging, a portion of incident electromagnetic energy that is reflected back or otherwise returned from the barcode symbol 102. Barcode symbol 102 may be interchangeably referred to herein as the target barcode symbol 102, or simply as the target, when the machine-readable symbol reader 104 is oriented towards a barcode symbol 102 intended for scanning or imaging. Furthermore, the barcode symbol 102 as described herein is intended to generally denote any of the various machine-readable symbologies now known or later developed.

The various embodiments described above can be combined to provide further embodiments. All of the above U.S. patents, patent applications and publications referred to in this specification, including but not limited to U.S. Provisional Patent Application No. 60/756,319 entitled METHOD AND SYSTEM FOR FACILITATING AIMING OF A MACHINE-READABLE SYMBOL READER, SUCH AS BARCODE READER, filed Jan. 4, 2006; U.S. Pat. No. 4,988,852 entitled BAR CODE READER, filed Mar. 19, 1990, issued to Krishnan; U.S. Pat. No. 5,378,883 entitled OMNIDIRECTIONAL WIDE RANGE HAND HELD BAR CODE READER, filed Jul. 19, 1991, issued to Batterman et al.; U.S. Pat. No. 6,330,974 entitled HIGH RESOLUTION LASER IMAGER FOR LOW CONTRAST SYMBOLOGY, filed Mar. 29, 1996, issued to Ackley; U.S. Pat. No. 6,484,944 entitled OPTOELECTRONIC DEVICE FOR ACQUIRING IMAGES OF PLANES, SUCH AS BAR CODE SYMBOLS, filed Sep. 6, 2000, issued to Manine et al.; and U.S. Pat. No. 6,732,930 entitled OPTOELECTRONIC DEVICE AND PROCESS FORACQUIRING SYMBOLS, SUCH AS BAR CODES, USING A TWO-DIMENSIONAL SENSOR, filed Dec. 22, 2000, issued to Massieu et al., are incorporated herein by reference, in their entirety, as are the sections in this specification. Aspects of the present systems and methods can be modified, if necessary, to employ systems, circuits and/or concepts of the various patents, applications and publications to provide yet further embodiments.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A machine-readable symbol reader operable to read machine-readable symbols, the machine-readable symbol reader comprising:
an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target; and
a detector subsystem operable produce a signal indicative of a non-visible component of electromagnetic energy returned from the surface.

2. The machine-readable symbol reader of claim 1 wherein the detector subsystem comprises:
a detector operable to detect the visible component and the non-visible component of electromagnetic energy returned from the surface; and
a filter operable to filter the visible component of the electromagnetic energy returned from the surface such that the detector receives only the non-visible component of the electromagnetic energy returned from the surface.

3. The machine-readable symbol reader of claim 1 wherein the detector subsystem comprises:
a detector substantially responsive to only the non-visible component of electromagnetic energy returned from the surface.

4. The machine-readable symbol reader of claim 1 wherein the illumination beam subsystem comprises:
a first emitter operable to emit only the visible component of electromagnetic energy; and
a second emitter operable to emit only the non-visible component of electromagnetic energy.

5. The machine-readable symbol reader of claim 1 wherein the detector subsystem comprises:
a detector operable to detect at least frequencies of the visible component and the non-visible component of the electromagnetic energy returned from the surface, and operable to generate a signal comprising:
information corresponding to the non-visible component of the electromagnetic energy returned from the surface; and
information corresponding to the visible component of electromagnetic energy returned from the surface; and
a signal processing system communicatively coupled to the detector and operable to computationally filter the information corresponding to the visible component of electromagnetic energy returned from the surface based upon a frequency of the visible component, such that substantially only the information corresponding to the non-visible component of electromagnetic energy returned from the surface is analyzed to determine the encoded information.

6. The machine-readable symbol reader of claim 1 wherein the detector subsystem comprises:
a detector operable to detect at least frequencies of the visible light and the non-visible electromagnetic energy, and operable to generate a signal comprising:
information corresponding to the non-visible electromagnetic energy;
information corresponding to the visible light; and
a signal processing system communicatively coupled to the detector and operable to computationally select the information corresponding to the non-visible electromagnetic energy such that the selected information is analyzed to determine the encoded information.

7. The machine-readable symbol reader of claim 6 wherein the signal processing system is further operable to resolve the machine-readable symbol.

8. The machine-readable symbol reader of claim 7 wherein the signal processing system if further operable to decode the resolved machine-readable symbol.

9. A machine-readable symbol reader operable to read machine-readable symbols, the machine-readable symbol reader comprising:
an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target; and
a detector subsystem comprising an optical filter that passes a non-visible component of electromagnetic energy returned from the surface while filtering a visible component of the electromagnetic energy returned from the surface.

10. The machine-readable symbol reader of claim 9 wherein the detector subsystem further comprises:
a detector operable to detect electromagnetic energy passed by the optical filter such that the detector detects the non-visible component of electromagnetic energy passed from the filter, and further operable to generate a signal corresponding to the detected non-visible component of electromagnetic energy passed from the filter.

11. The machine-readable symbol reader of claim 10, further comprising;
a processing system operable to receive the signal and operable to determine information encoded in the machine-readable symbols based upon the received signal.

12. A machine-readable symbol reader operable to read machine-readable symbols, the machine-readable symbol reader comprising:
an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target; and
a detector subsystem comprising a detector responsive to a non-visible component of electromagnetic energy returned from the surface and substantially unresponsive to a visible component of the electromagnetic energy returned from the surface.

13. The machine-readable symbol reader of claim 12 wherein the detector is operable to detect a range of non-visible electromagnetic energy about a nominal wavelength value, wherein the nominal wavelength value corresponds to at least a wavelength of the non-visible component of electromagnetic energy returned from the surface.

14. The machine-readable symbol reader of claim 12 wherein the detector subsystem further comprises:
an optical filter operable to remove at least the visible component of the electromagnetic energy returned from the surface, and operable to pass the non-visible component of the electromagnetic energy returned from the surface; and
a charge coupled device (CCD) array operable to detect the non-visible component of the electromagnetic energy returned from the surface and passed by the optical filter.

15. A machine-readable symbol reader operable to read machine-readable symbols, the machine-readable symbol reader comprising:
an illumination beam subsystem operable to emit electromagnetic energy outwards along a line-of-sight from the machine-readable symbol reader, the electromagnetic energy comprising a non-visible component and a visible component, the visible component capable of forming a visual pattern on a surface indicative of a position of the machine-readable symbol reader with respect to a target; and
a detector subsystem comprising a filter operable pass a signal indicative of a non-visible component of electromagnetic energy returned from the surface while substantially filtering a signal indicative of a visible component of the electromagnetic energy returned from the surface.

16. The machine-readable symbol reader of claim 15 wherein the detector subsystem further comprises:
a detector operable to detect the visible and the non-visible components of electromagnetic energy returned from the surface, wherein the filter comprises a signal processing system operable to receive a signal from the detector corresponding to the visible and the non-visible components of electromagnetic energy detected by the detector, operable to computationally filter the visible component of electromagnetic energy, and further operable to generate a second signal indicative of the non-visible component of electromagnetic energy returned from the surface.

17. The machine-readable symbol reader of claim 16, further comprising:
a processing system operable to received the generated second signal indicative of the non-visible component of electromagnetic energy returned from the surface such that the generated second signal is processed to determine information encoded in the target.

18. The machine-readable symbol reader of claim 15 wherein the detector subsystem further comprises:
a detector operable to detect the visible and the non-visible components of electromagnetic energy returned from the surface; and
a signal processing system operable to receive a signal from the detector corresponding to the visible and the non-visible components of electromagnetic energy detected by the detector, operable to computationally determine the non-visible component of electromagnetic energy, and further operable to determine information encoded in the target based upon the determined non-visible component of electromagnetic energy.

19. A method of operating a machine-readable symbol reader to read machine-readable symbols, the method comprising:
emitting electromagnetic energy comprising a visible component and a non-visible component from the machine-readable symbol reader, wherein the emitted visible component forms a pattern indicative of a position of the machine-readable symbol reader with respect to a target;
receiving a portion of the emitted electromagnetic energy returned from the target, wherein the received portion of the electromagnetic energy comprises a visible portion and a non-visible portion of electromagnetic energy; and
detecting only the received non-visible portion of electromagnetic energy.

20. The method of claim 19 wherein the target is a machine-readable symbol and further comprising:
determining information encoded in the machine-readable symbol based only upon the detected non-visible portion of electromagnetic energy.

21. The method of claim 19, further comprising:
filtering the visible portion of electromagnetic energy detected with a filter such that only the non-visible portion of electromagnetic energy substantially remains.

22. The method of claim 19, further comprising:
emitting the visible component of electromagnetic energy from a first emitter; and
concurrently emitting the non-visible component of electromagnetic energy from a second emitter.

23. The method of claim 19, further comprising:
concurrently emitting the visible component and the non-visible component of electromagnetic energy from a single emitter.

24. A method for determining machine-readable encoded information in machine-readable symbols, the method comprising:
generating a signal based upon a detected portion of electromagnetic energy that is returned from a machine-readable symbol, the electromagnetic energy comprising to a visible component and a non-visible component;
preprocessing the signal to substantially remove the visible component of electromagnetic energy; and
processing substantially only the information corresponding to the non-visible component of electromagnetic energy in the signal to resolve the machine-readable symbol.

25. The method of claim 24, wherein preprocessing comprises electronically filtering the visible component of electromagnetic energy such that substantially only information corresponding to the non-visible component of electromagnetic energy remains in the preprocessed signal.

26. The method of claim 24, wherein preprocessing comprises computationally filtering the visible component of electromagnetic energy such that only information corresponding to the non-visible component of electromagnetic energy remains in the preprocessed signal.

27. A system for determining encoded information in a plurality of machine-readable symbols, comprising:
means for concurrently emitting visible and non-visible electromagnetic energy onto a machine-readable symbol;
means for concurrently receiving a visible component and a non-visible component of electromagnetic energy that is returned back from the machine-readable symbol; and
means for detecting substantially only the returned non-visible component of electromagnetic energy.

28. The system of claim 27 wherein the means for concurrently emitting comprises:
a first emitter operable to emit the visible electromagnetic energy; and
a second emitter operable to emit the non-visible electromagnetic energy.

29. The system of claim 27, further comprising:
means for generating a signal corresponding to the non-visible component of electromagnetic energy returned; and
means for determining information from the generated signal, wherein the determined information corresponds to the encoded information.

30. The system of claim 27, further comprising:
means for filtering the visible component of electromagnetic energy returned, such that the means for detecting substantially detects only the non-visible component of electromagnetic energy returned.
